(19) United States
(12) Patent Application Publication
(10) Pub. No.: US 2013/0216991 A1
(43) Pub. Date: Aug. 22, 2013

(54) Interactive Attachment For Childrens Bottle

(71) Applicant: Sandi Sinnamond, West Chicago, IL (US)

(72) Inventor: Sandi Sinnamond, West Chicago, IL (US)

(21) Appl. No.: 13/401,137

(22) Filed: Feb. 21, 2012

(51) Int. Cl. G09B 19/24

(52) U.S. Cl. 434/260

(57) ABSTRACT

The present invention relates to a bottle attachment having a generally tubular sleeve that removably attaches to the exterior of a conventional children's bottle. A plurality of fasteners are affixed to the exterior of the sleeve. Children may manipulate the fasteners to promote the development of learning and fine motor skills and hand-to-eye coordination. A plurality of images may be disposed below flaps affixed to the exterior of the sleeve. Children may selectively lift the flaps to reveal the images, thereby promoting learning. The selection and arrangement of the fasteners and images provide distinctive ornamentation to allow a bottle to be readily identifiable when several bottles may be present in the same location.

### BACKGROUND OF THE INVENTION

1. Field of the Invention

The present invention relates to a device for attachment to a bottle. More specifically, the invention relates to a device for attachment to a children's bottle having a plurality of interactive elements for promoting learning and the development of fine motor skills and hand-to-eye coordination in children.

2. Description of the Related Art

Various enhancements to children's bottles for promoting learning and providing entertainment are known. For example, attachments for bottles may employ sounds, music, shapes, pictures and/or colorful lights. Various enhancements to bottles for thermal insulating, heating and cooling are also known. For example, U.S. Pat. No. 6,523,364 provides a water bottle cooling jacket and U.S. Pat. No. 5,901,882 provides a squeeze bottle with insulating jacket.

Notwithstanding their advantages, however, such enhancements are subject to certain limitations and do not effectively develop fine motor skills (dexterity) and hand-to-eye coordination in children.

There is a need in the art to provide a device in connection with a bottle that encourages children to use their fingers. There is also a need in the art to provide a device in connection with a bottle that introduces children to various fasteners that may be encountered in daily activities. There is further a need in the art to provide a device in connection with a bottle that provides children the opportunity to develop fine motor skills and hand-to-eye coordination. There is also a need to introduce a young child to other cultures, animals, and in a broad sense, the world around the child. There is also a need to introduce children to shapes, colors and textures.

It is desirable, therefore, to provide an improved bottle attachment having a plurality of interactive elements for promoting learning and the development of fine motor skills (dexterity) and hand-to-eye coordination in children, without the limitations of prior art bottles and bottle attachments.

It is a primary object of the present invention to provide a bottle attachment that promotes learning and the development of fine motor skills (dexterity) in children.

It is also an object of the present invention to provide a bottle attachment that promotes learning and the development of hand-to-eye coordination in children.

Another objective of the present invention is to provide a bottle attachment including a variety of common fasteners for children to manipulate. Fasteners may include but are not limited to: zippers, hook-and-loop or Velcro® fasteners, buttons, snaps, hook-n-eye fasteners, ties, latches, laces, or buckles.

Another objective of the present invention is to provide a bottle attachment including a variety of images that are revealed and introduce children to other cultures, animals, foods, plants, numbers, letters, space, the ocean, the desert, the mountains, and the range of categories that are similar in nature yet too numerous to list.

Another objective of the present invention is to provide entertainment, delight and adventure for children by providing a bottle attachment including objects to be discovered as the children lift flaps to reveal a variety of images.

Another objective of the present invention is to provide a bottle attachment including flaps or images in a variety of colors, shapes, textures or noises.

A further object of the present invention is to provide a bottle attachment that will assist in preventing condensation from leaking onto children's clothes or their surroundings.

Another objective of the present invention is to provide a thermal insulating bottle attachment for a standard children's bottle.

A further object of the present invention is to provide a bottle attachment providing entertainment for a child who may not be able to move about freely, i.e. at doctor's office or hospital, car ride, church, trains or planes, shopping excursions, at the zoo, at museum, school activities, or other times while in a lap, seat or stroller.

Another objective of the present invention is to allow the distinctive ornamentation on a bottle attachment to provide a readily identifiable bottle when several children may be present in the same location.

Yet another object of the present invention is to provide virtually unlimited possibilities of combinations for fasteners, categories or images to be assembled on a bottle attachment and therefore offer ample opportunity to provide a wide variety of learning to children.

It is therefore an object of the present invention to provide a bottle attachment having a plurality of interactive elements for promoting learning and the development of fine motor skills (dexterity) and hand-to-eye coordination in children.

These together with other objects of the invention, along with the various features of novelty which characterize the invention, are pointed out with particularity in the detailed description annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### SUMMARY OF INVENTION

A broad aspect of the invention comprises a bottle attachment comprising a generally tubular sleeve that removably attaches to the exterior of a conventional children's bottle. A plurality of fasteners are affixed to the exterior of the sleeve. Children may manipulate the fasteners to promote the development of learning and fine motor skills and hand-to-eye coordination. A plurality of images may be disposed below flaps affixed to the exterior of the sleeve. Children may selectively lift the flaps to reveal the images, thereby promoting learning. The selection and arrangement of the fasteners and images provide distinctive ornamentation to allow a bottle to be readily identifiable when several bottles may be present in the same location.

There has been outlined, rather broadly, the more important features of the invention in order that the detailed description thereof that follows may be better understood, and in order that the present contribution to the art may be better appreciated.

There are, of course, additional features of the invention that will be described hereinafter and that will form the subject matter of the invention.

As such, those skilled in the art will appreciate that the conception, upon which this disclosure is based, may readily be utilized as a basis for designing of other structures, methods, and systems for carrying out the several purposes of the present invention. It is important, therefore, that the claims be regarded as including such equivalent constructions in so far as they do not depart from the spirit and scope of the present invention.

Further, the purpose of the abstract is to enable the US patent and trademark office and the public generally, and especially the scientists, engineers and practitioners in the art who are not familiar with the patent or legal terms or phraseology, to determine quickly from what cursory inspection the nature and essence of the technical disclosure of the application. The abstract is neither intended to define the invention of the application, which is measured by the claims, nor is it intended to be limiting as to the scope of the present invention in any way.

### BRIEF DESCRIPTION OF THE SEVERAL VIEWS OF THE DRAWINGS

FIG. 1 is a perspective view of the bottle attachment, constructed in accordance with a preferred embodiment of the present invention, disposed on a conventional children's bottle, illustrating a plurality of fasteners promoting learning and the development of fine motor skills and hand-to-eye coordination in children;

FIG. 2 is a cross-sectional view taken along line 2-2 of FIG. 1; and

FIG. 3 is a rear perspective view of the bottle attachment, constructed in accordance with an alterative embodiment of the present invention, disposed on a conventional children's bottle, illustrating images selectively hidden below flaps for promoting learning and the development of fine motor skills and hand-to-eye coordination in children.

### DETAILED DESCRIPTION OF THE INVENTION

Before explaining the preferred embodiment of the present invention in detail, it is to be understood that the present invention is not limited in its application to the details of construction and to the arrangements of the components set forth in the following description or illustrated in the drawings. The present invention is capable of other embodiments and of being practiced and carried out in various ways. Also, it is to be understood that the phraseology and terminology employed herein are for the purpose of description and should not be regarded as limiting.

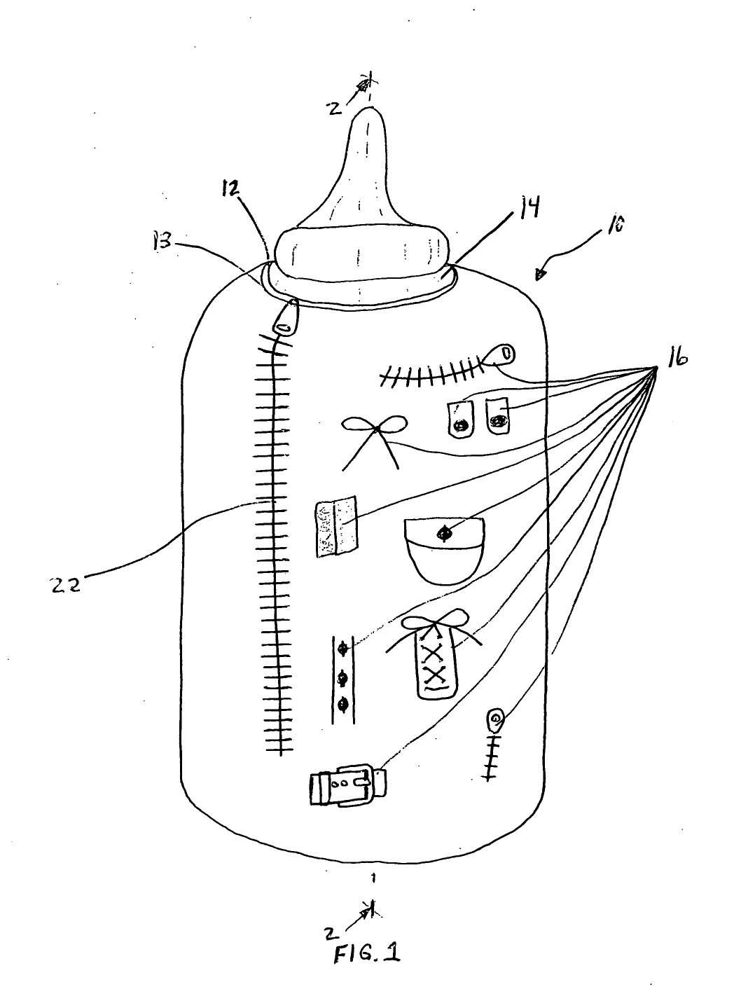

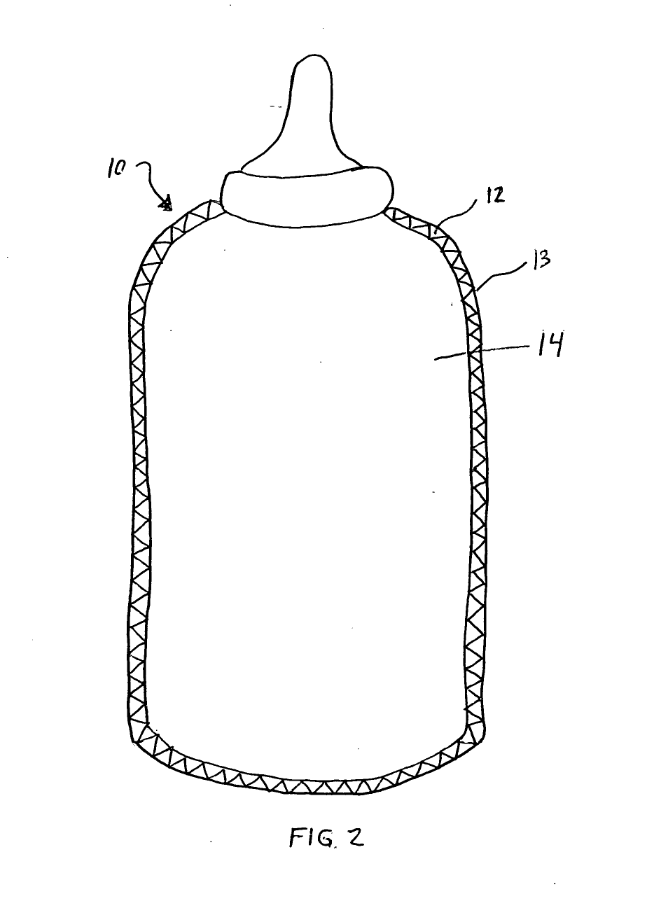

Referring to FIGS. 1-3, there is provided a bottle attachment 10 that promotes learning and the development of fine motor skills in children. The bottle attachment 10 of the preferred embodiment of the present invention comprises a generally tubular sleeve 12 that removably attaches to the exterior of a conventional children's bottle 14.

The entirety of U.S. Pat. No. 6,523,364, providing a water bottle cooling jacket, and U.S. Pat. No. 5,901,882, providing a squeeze bottle with insulating jacket, are incorporated by reference herein to illustrate known means for attaching a generally tubular sleeve to the exterior of a bottle.

In the preferred embodiment of the invention illustrated in FIG. 1, a plurality of fasteners 16 are affixed to the exterior 13 of the sleeve 12. In operation, children manipulate the fasteners 16 to promote the development of fine motor skills and hand-to-eye coordination. In the preferred embodiment, the fasteners 16 include zippers, hook-and-loop or Velcro® fasteners, buttons, snaps, hook-n-eye fasteners, ties, latches, laces, buckles, and the like, although it should readily understood by those skilled in the art that a variety of other suitable fasteners, such as grommets, drawstrings, alligator clips, clasps, or magnets, may be employed.

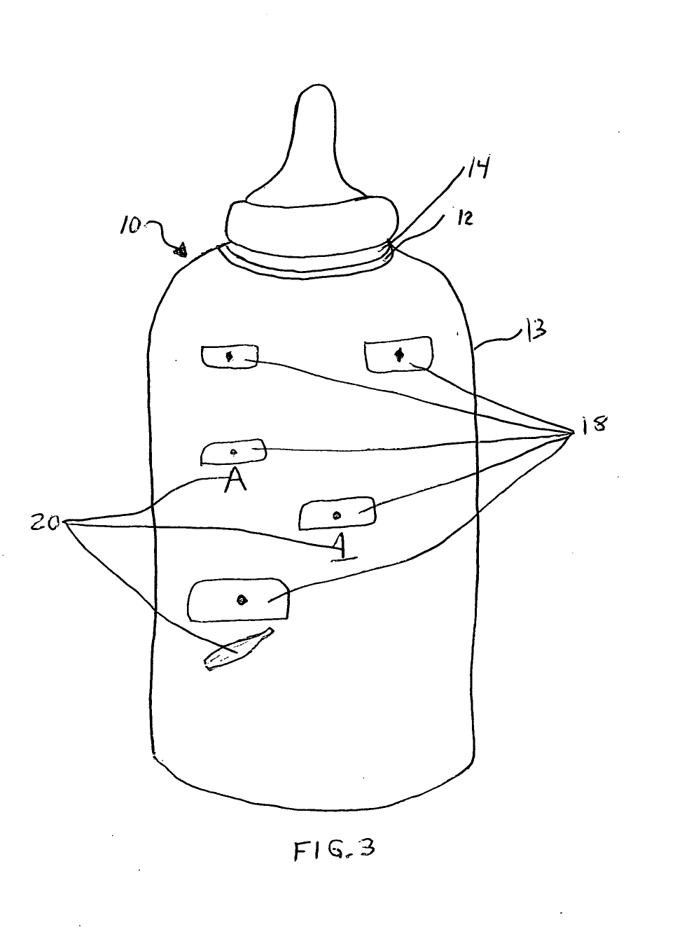

In an alternative embodiment of the invention illustrated in FIG. 3, a plurality of images 20 are disposed below flaps 18 affixed to the exterior of the sleeve 12. In operation, children selectively lift the flaps 18 to reveal the images 20, thereby promoting learning.

In the preferred embodiment, the images 20 include cultural images, animals, foods, plants, numbers, letters, space, the ocean, the desert, the mountains, and the like, although it should readily understood by those skilled in the art that a variety of other suitable images may be employed.

In the preferred embodiment of the invention, the generally tubular sleeve 12 is removably attachable by use of a zipper 22. The generally tubular sleeve 12 is preferably constructed of long woven stretch material, although it should readily understood by those skilled in the art that a variety of other suitable materials may be employed. At least a portion of the generally tubular sleeve 12 may be constructed of a material having thermal insulating properties.

In operation, the selection and arrangement of the fasteners 16 and images 20 provide distinctive ornamentation to allow a bottle to be readily identifiable when several bottles may be present in the same location.

In alternative embodiments, the flaps 18 may be constructed of different fabrics for tactile stimulation. For example, the flaps 18 may be constructed of cotton, silk, suede, velour, fleece, quilt, or the like. The flaps 18 may also provide different shapes for spatial learning. For example, each of the flaps 18 may form a circle, square, rectangle, triangle, abstract, or the like. The flaps 18 may also be different colors for visual learning. The flaps 18 may also have patterns for theme, such as: animals, numbers, geography, space, seas, and the like. The flaps 18 may also have images on their fronts with a complimentary item to be revealed. For example: a number spelled out on the flap and the figure shown beneath in a shiny vinyl; a bug pattern reveals a three-dimensional bug of the pattern; an image of an eye will reveal a mirror or a photo of the child in a clear sleeve; a green suede mountain shape will lift to show a grizzly bear; or the like. The flaps 18 may be tethered by various fasteners 16 which can be opened as the fasteners 16 permit.

As children explore and understand the workings of the fasteners 16, the flaps 18 then are opened and images 20 are found by the children in this captivating learning experience.

While the invention has been described in connection with a preferred embodiment and several alternative embodiments, it will be understood that it is not intended that the invention be limited to those embodiments. On the contrary, it is intended to cover all alternatives, modifications and equivalents as may be included within the spirit and scope of the invention as disclosed.

As to the manner of usage and operation of the instant invention, same should be apparent from the above disclosure, and accordingly no further discussion relevant to the manner of usage and operation of the instant invention shall be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered illustrative of only the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The foregoing discussion is illustrative of the invention. However, since many embodiments of the invention can be made without departing from the spirit and scope of the invention, the invention resides wholly in the claims hereinafter appended.

I claim:

1. A bottle attachment comprising:
a generally tubular sleeve removably attachable to the exterior of a bottle;
a plurality of interactive elements for promoting learning and the development of fine motor skills and hand-to-eye coordination in children.

2. The bottle attachment of claim 1 wherein the interactive elements comprise fasteners.

3. The bottle attachment of claim 2 wherein the fasteners are selected from the group consisting of zippers, hook-and-loop or Velcro® fasteners, buttons, snaps, hook-n-eye fasteners, ties, latches, laces, buckles, and combinations thereof.

4. The bottle attachment of claim 1 wherein at least a portion of the generally tubular sleeve is constructed of a material having thermal insulating properties.

5. The bottle attachment of claim 1 wherein the interactive elements comprise a plurality of images disposed below flaps affixed to the exterior of the sleeve.

6. The bottle attachment of claim 5 wherein the images are selected from the group consisting of cultural images, animals, foods, plants, numbers, letters, space, the ocean, the desert, the mountains, and combinations thereof.

7. A method of promoting learning and the development of fine motor skills and hand-to-eye coordination in children comprising the steps of:
providing a generally tubular sleeve removably attached to the exterior of a bottle;
affixing a plurality of interactive elements to the exterior of the sleeve; and
allowing children to selectively manipulate the interactive elements.

8. The method of promoting learning and the development of fine motor skills and hand-to-eye coordination in children in claim 7 wherein the interactive elements comprise fasteners.

9. The method of promoting learning and the development of fine motor skills and hand-to-eye coordination in children in claim 8 wherein the fasteners are selected from the group consisting of zippers, hook-and-loop or Velcro® fasteners, buttons, snaps, hook-n-eye fasteners, ties, latches, laces, buckles, and combinations thereof.

10. The method of promoting learning and the development of fine motor skills and hand-to-eye coordination in children in claim 7 wherein at least a portion of the generally tubular sleeve is constructed of a material having thermal insulating properties.

11. The method of promoting learning and the development of fine motor skills and hand-to-eye coordination in children in claim 10 wherein the interactive elements comprise images.

12. The method of promoting learning and the development of fine motor skills and hand-to-eye coordination in children in claim 11 wherein the images are selected from the group consisting of cultural images, animals, foods, plants, numbers, letters, space, the ocean, the desert, the mountains, and combinations thereof.
